(19) United States
(12) Patent Application Publication
(10) Pub. No.: US 2026/0328679 A1
(43) Pub. Date: Oct. 22, 2026

(54) AN ASSEMBLY FOR MEASUREMENTS OF ONE OR MORE OPTICAL PARAMETERS OF A MEDIUM AND A METHOD OF USING THE ASSEMBLY

(71) Applicant: Spec-Imaging AB

(72) Inventor: William René Serge CHAZE, Eslöv (SE)

(21) Appl. No.: 19/116,773

(22) PCT Filed: Sep. 28, 2023
(86) PCT No.: PCT/SE2023/050960

§ 371 Date: Mar. 28, 2025

(30) Foreign Application Priority Data
Sep. 30, 2022 (SE) 2251124-0

(51) Int. Cl. G01N 21/31

(52) U.S. Cl. CPC G01N 21/31; G01N 2201/0634

(57) ABSTRACT

The disclosure relates to an assembly for measurements of one or more optical parameters of a medium, the assembly comprising: a light sheet generator (110) configured to provide a light sheet (192) extending in a first spatial dimension (101), wherein the light sheet (192) has a propagation path in a second spatial dimension (102), wherein the light sheet generator (110) comprises a polychromatic light source emitting polychromatic light and light sheet generating optics to reform the light from the polychromatic light source into the light sheet (192); a light intensity modulator (130) configured to provide an intensity modulated light sheet (193) by applying—to the light sheet (192)—an intensity modulation having a periodical, or substantially periodical, pattern (11,12,13) in the first spatial dimension (101); a holder (145) for a sample (140) of the medium, configured to enable the intensity modulated light sheet (193) to illuminate the sample; a dispersive element (3) arranged to receive the light transmitted through the sample and arranged to split the light sheet into its spectral components so that each spectral component forms its own separated light sheet; and an optical sensor configured to record the separated light sheets (195) in two dimensions. The disclosure further relates to a method of using the assembly.

### TECHNICAL FIELD

The present disclosure relates to an assembly for measurements of one or more optical parameters of a medium and a method of using the assembly. More specifically, the disclosure relates to an assembly for measurements of one or more optical parameters of a medium and a method of using the assembly as defined in the introductory parts of the independent claims.

### BACKGROUND ART

In some conventional approaches to spectrophotometric measurements, monochromatic light (e.g., selected from a polychromatic light source) is used to illuminate a medium under examination, and a photodetector is placed on the opposite side of the medium compared to the illuminated side to record the remaining light intensity after passing through the sample. An absorption or attenuation coefficient of the medium may be determined for the wavelength of the monochromatic light by calculating a ratio between light intensity before and after passing of the sample.

More elaborate approaches to spectrophotometric measurements are also known. For example, a system for measuring optical properties of a medium, which applies monochromatic light, is described in WO 2012/015344 A1. A further example, an assembly for spectrophotometric measurements of turbid samples, is disclosed in WO 2020/180233 A1. There, spatially modulated illumination is employed to mark incident illumination, allowing unwanted multiply scattered light to be suppressed.

A problem with prior art solutions to spectrophotometric measurements is efficiency for performing the measurements and accuracy of the archived results.

Therefore, there is a need for alternative approaches to spectrophotometric measurements. The need may be particularly prominent for measurements on turbid media.

### SUMMARY

Transmission Structured Laser Illumination Planar Imaging (SLIPI) produces a much stronger signal than 2D imaging orthogonal SLIP where side scattering is measured. To have the SLIP measurement spectrally resolved the light sheet used has previously been spectrally resolved in the planar direction perpendicular to the propagation direction of the plane. This limits the measurement signal and the spectral resolution, especially when using a single-phase configuration without phase shifting of the structured illumination.

It is an object of the present disclosure to mitigate, alleviate or eliminate one or more of the above-identified deficiencies and disadvantages in the prior art and solve at least the above mentioned problem. According to a first aspect there is provided an assembly for measurements of one or more optical parameters of a medium, the assembly comprising: a light sheet generator configured to provide a light sheet extending in a first spatial dimension, wherein the light sheet has a propagation path in a second spatial dimension, wherein the light sheet generator comprises a polychromatic light source emitting polychromatic light and light sheet generating optics to reform the light from the polychromatic light source into the light sheet; a light intensity modulator configured to provide an intensity modulated light sheet by applying—to the light sheet—an intensity modulation having a periodical, or substantially periodical, pattern in the first spatial dimension; a holder for a sample of the medium, configured to enable the intensity modulated light sheet to illuminate the sample; a dispersive element arranged to receive the light transmitted through the sample and arranged to split the light sheet into its spectral components so that each spectral component forms its own separated light sheet; and an optical sensor configured to record the separated light sheets in two dimensions. The assembly for measurements of one or more optical parameters of a medium can resolve a transmission Structured Laser Illumination Planar Imaging measurement spectrally. As the sheet is not spectrally diversified before entering the sample, but instead spectrally resolved after the sample a lot of information is gained and the signal strength is also enhanced considerably. As the diffraction direction is perpendicular to the modulation direction, modulation frequency does not affect the spectral resolution anymore and therefore higher spectral resolution can be reached. In addition, generating the modulated light sheet is simplified since the light beam does not have to be diffracted before being shaped into a sheet and modulated in intensity.

The light sheet generating optics is any combination of lenses for forming a sheet, e.g. a cylindrical concave lens followed by a circular convex lens or any other setup used to form a lens, including an optional slit to further shape the sheet.

According to some embodiments, the dispersive element is a diffraction grating, which is advantageous as it is a light weight dispersive component.

According to some embodiments, the dispersive element is a prism, which is advantageous as it disperse the light with very high accuracy.

According to some embodiments, the light sheet generator is arranged fastened and abutting to the light intensity modulator. An advantage with this embodiment is that the assembly can be made more compact.

According to some embodiments, the light intensity modulator is arranged fastened and abutting to abutting the sample holder. An advantage with this embodiment is that the assembly can be made more compact.

According to some embodiments, the light intensity modulator is an imprint on the sample holder or container. An advantage with this embodiment is that the assembly can be made more compact.

According to some embodiments, the optical sensor is a 2D CCD camera, allowing an accurate 2D recording.

According to some embodiments, light intensity modulator comprises: an optical holder for a grating, the optical holder being electronically controlled and movable in the third spatial dimension; and a grating comprising a plurality of periodical pattern. An advantage with this embodiment is that the phase of the intensity modulated light sheet can be rapidly changed so as to, combined with previous recordings, gain the parts that where dark in the intensity modulated light sheet gaining signal strength and resolution of the measurement.

According to some embodiments, light intensity modulator comprises: an optical holder for a grating, the optical holder being electronically controlled and movable in the first spatial dimension; and a grating comprising a periodical pattern. An advantage with this embodiment is that the phase of the intensity modulated light sheet can be rapidly changed so as to, combined with previous recordings, gain the parts that where dark in the intensity modulated light sheet gaining signal strength and resolution of the measurement.

According to a second aspect there is provided a method of using the assembly according to the first aspect for measuring one or more optical parameters of a medium, the method comprising: providing the holder with a sample of the medium; illuminating the sample by the intensity modulated light sheet provided by the light sheet generator and the light intensity modulator of the assembly; recording, by the optical sensor of the assembly, a plurality of separated light sheets; and determining the one or more optical parameters based on the recorded plurality of separated light sheets.

According to some embodiments the method further comprises: moving the optical of the light intensity modulator in the third spatial dimension so that light propagating in the assembly hits the next subsequent first periodic pattern of the grating or, if present, second periodic pattern; iterating the method from the illuminating step.

According to some embodiments, the method further comprises: moving the optical holder of the light intensity modulator in the first spatial dimension a predetermined portion of a phase of the periodical pattern so that light propagating in the assembly is phase shifted the predetermined portion of a phase; iterating the method from the illuminating step.

Effects and features of the second aspect are to a large extent analogous to those described above in connection with the first aspect. Embodiments mentioned in relation to the first aspect are largely compatible with the second aspect.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1a shows a schematic block diagram illustrating an example assembly according to some embodiments viewed in the third spatial direction.

FIG. 1b shows a schematic block diagram illustrating the example assembly shown in FIG. 1a viewed in the first spatial direction.

FIG. 2 shows a perspective view of parts of the assembly as disclosed in FIGS. 1a and 1b.

FIG. 3 shows an example of a grating according to the present disclosure with a periodic pattern.

FIG. 4 shows an example of a grating according to the present disclosure with a phase shift between a plurality of periodic patterns.

FIG. 5 shows is a flowchart illustrating example method steps according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

As mentioned above, many conventional approaches to spectrophotometric measurements uses successively applied monochromatic beams to illuminate the sample of the medium under examination. To acquire information for more than one wavelength, a scan through all wavelengths of interest needs to be performed. Such approaches may be inefficient for performing measurements.

Another approach to spectrophotometric measurements is described in “Quantitative measurements of turbid liquids via structured laser illumination planar imaging where absorption spectrophotometry fails”; Regnima, et al.; Applied Optics, vol. 56, no. 13, May 2017, pp. 3929-3938, where two lasers are used having wavelengths 450 nm and 638 nm, respectively, and activating one laser at a time for measurements.

Further approaches to spectrophotometric measurements are described in WO 2012/015344 A1 and WO 2020/180233 A1.

In the following, embodiments will be described whereby efficient and accurate measurements are enabled. Furthermore, some embodiments provide increased flexibility in measuring optical properties of the medium under examination. Thereby, accurate measurements can be carried out by the same assembly for media having a wide range of various optical properties.

Generally, the term “measurements” may, for example, refer to spectrophotometric measurements.

Also generally, the term “optical parameters” may refer to any suitable optical parameter describing an optical property; such as, for example, an absorption coefficient, an attenuation coefficient (a.k.a. an extinction coefficient), a scattering coefficient, a fluorescence quantum yield (QY), a phosphorescence quantum yield (QY), etc. The extinction coefficient equals the sum of the absorption coefficient and the scattering coefficient. Other examples of optical properties include properties linked to one or more of: a concentration, an averaged cross-section, and a particle size (if there are particles in the medium). Thus, these parameters may also be derived. Hence, measuring an optical parameter may be defined as measuring an (the corresponding) optical property.

Also generally, the term “medium” may, for example, refer to a liquid, a gel, a solid medium, or a gas. Some common applications include liquid media. Some embodiments may be particularly suitable for measurements in relation to turbid and/or emitting media, wherein turbid includes scattering and absorption and emission includes photoluminescence (e.g., fluorescence and/or phosphorescence).

Also generally, exemplification by scattering is meant to be relevant also for emission of photoluminescing media, and vice versa.

Also generally, the term “light” refers to electromagnetic radiation having a wavelength within a certain range. This range may comprise what is commonly referred to as visible light (i.e., a portion of the electromagnetic radiation spectrum that is visible to the human eye). Alternatively or additionally, this range may comprise what is commonly referred to as non-visible light (i.e., a portion of the electromagnetic radiation spectrum that is not visible to the human eye), for example infrared (IR) light and/or ultraviolet (UV) light. The term “illumination” refers to irradiation by light as defined above.

Also generally, the term “polychromatic” describes something comprising two or more (visible or non-visible) wavelengths of the electromagnetic radiation spectrum.

Also generally, the term (single) optical sensor may refer to an array/matrix of constituent optical sensors (such as a digital camera where each pixel has a corresponding constituent optical sensor; an optical detector) or to a single optical sensor element (a single optical detector) that is configured to sweep over a recording area.

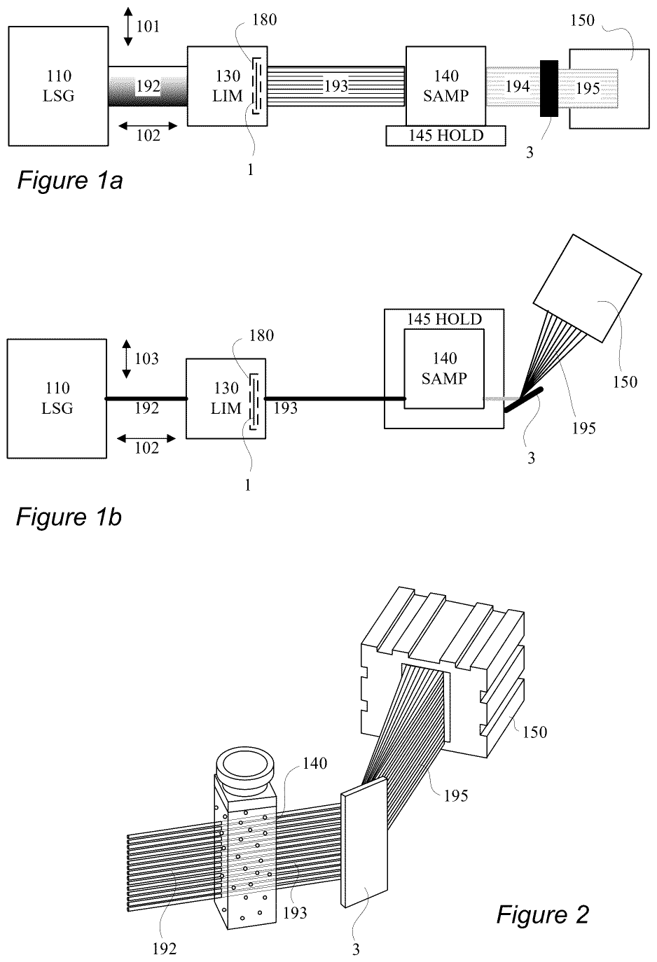

FIGS. 1a and 1b schematically illustrates an example assembly according to some embodiments, for measurements of one or more optical parameters of a medium. FIG. 1a illustrates a side wave of one variant of the assembly and FIG. 1b illustrate a top views of the assembly.

The assembly comprises a light sheet generator (LSG) 110, a light intensity modulator (LIM) 130, a holder (HOLD) 145 for a sample (SAMP) 140 of the medium, a diffraction grating 3, and an optical sensor (SENS) 150.

The light sheet generator 110 is configured to provide a polychromatic light sheet 192 with a propagation path in a second spatial dimension 102.

The second spatial dimension is non-parallel (typically orthogonal) to the first spatial dimension (e.g., in Euclidean coordinates). Together with a third spatial dimension 103 (which is non-parallel, typically orthogonal, to the first spatial dimension and to the second spatial dimension), the first and second spatial dimension spans a three-dimensional space. The terms “spatial dimension” and “dimension” will be used interchangeably herein.

A light sheet may, for example, be defined as light propagating along two or more paths in a single plane (e.g., in Euclidean coordinates).

That the light spectrum extends in the first spatial dimension may be understood as a light wavelength variation, which has the property that each coordinate along a path in the first spatial dimension experiences at most one wavelength of light.

The light intensity modulator (LIM) 130 comprises an optical holder 180 holding a grating 2, 4 for modulating the light sheet 192. The light intensity modulator 130 is configured to provide an intensity modulated polychromatic light sheet 193 by applying (to the polychromatic light sheet) an intensity modulation having a periodical—or substantially periodical—pattern in the first spatial dimension.

Examples of periodical patterns include patterns defined by a Ronchi ruling—i.e., a constant-interval bar and space square wave (e.g., equaling a when 2kb≤x<(2k+1)b, and equaling c when (2k+1)b≤x<(2k+2 )b, k∈Z) as shown in FIG. 2—and patterns defined by a sinusoidal function. Examples of substantially periodical patterns include any pattern that alters between values below its mean value and values above its mean value in a certain periodicity over x, but where the values below its mean value and/or the values above its mean value can be different for different periods. Another example of a substantially periodical pattern is a pattern with a slight periodicity shift along x. Further periodic patterns may thereby be triangular masks, or any periodical pattern mask.

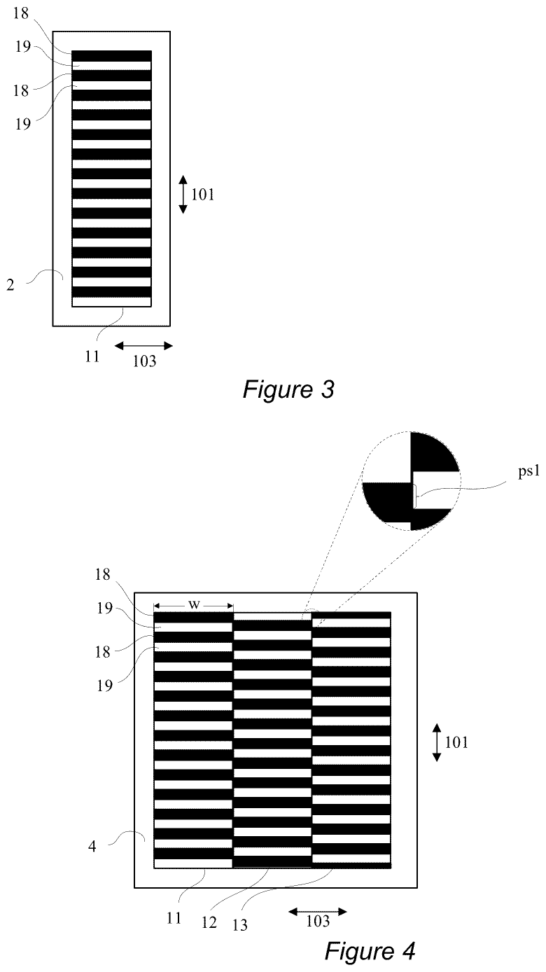

The light intensity modulator may, for example, be a Ronchi grating. One example Ronchi grating 1 is illustrated in FIGS. 3 and 4.

The Ronchi grating of FIG. 3 comprises a periodical patterns 11. The grating is intended to be movable to phase shift the periodical pattern. In the example of FIGS. 1b and 2, the grating would be movable in the first dimension 101 for this purpose.

The Ronchi grating of FIG. 4 comprises a three periodical patterns 11, 12, 13 placed next to each other. The middle periodical pattern 12 has a phase shift ps1 of 120 degrees to the right periodic pattern 13 and to the left periodic pattern 11. The grating is intended to be movable to select one of the plurality of phase shifted periodical patterns for application. In the example of FIGS. 1b and 2, the grating would be movable in the third dimension 103 for this purpose.

The grating of FIG. 4 comprises a base plate 2 extending in a plane in two spatial directions 102,103 and a plural number n of periodic patterns 11,12,13, each with a surface 18 and space 19 periodic wave optical mask of the same interval frequency as shown in FIG. 4. The periodic pattern 11,12,13 is arranged adjacent each other in the base plate 4 with a phase shift ps1 between the masks of adjacent first periodic patterns. As disclosed in FIG. 4 the first phase shift ps1 is 360/n degrees. With n being three as in FIG. 4, the phase shift ps1 is 120 degrees.

Referring again to FIGS. 1a, 1b and 2 the first aspect of this disclosure shows an assembly for measurements of one or more optical parameters of a medium, the assembly comprising: a light sheet generator 110 configured to provide a light sheet 192 extending in a first spatial dimension 101, wherein the light sheet 192 has a propagation path in a second spatial dimension 102, wherein the light sheet generator 110 comprises a polychromatic light source emitting polychromatic light and light sheet generating optics to reform the light from the polychromatic light source into the light sheet 192; a light intensity modulator 130 configured to provide an intensity modulated light sheet 193 by applying—to the light sheet 192—an intensity modulation having a periodical, or substantially periodical, pattern 11,12,13 in the first spatial dimension 101; a holder 145 for a sample 140 of the medium, configured to enable the intensity modulated light sheet 193 to illuminate the sample; a dispersive element 3 arranged to receive the light transmitted through the sample and arranged to split the light sheet into its spectral components so that each spectral component forms its own separated light sheet; and an optical sensor configured to record the separated light sheets 195 in two dimensions. The spectrally separated light sheets are in the case of a uniform polychromatic light source in reality a continuum with an infinite number of sheets.

In FIGS. 1a, 1b, and 2 the dispersive element 3 is a diffraction grating, however, in other embodiments the dispersive element 3 may also be a prism. The optical sensor 150 is a 2D CCD camera.

It may be preferable to have the light intensity modulator located as close to the sample as possible, to preserve the spatial modulation until the modulated light sheet enters the sample. This is inherently achieved by the approach where the light intensity modulator is an imprint on the container for the sample.

Thus, the light sheet generator 110 may be arranged fastened and abutting to the light intensity modulator 130; the light intensity modulator 130 may be arranged fastened and abutting to abutting the sample holder 145; and the light intensity modulator may be an imprint on the sample holder 145 or container.

The holder 145 for the sample 140 of the medium is configured to enable the intensity modulated polychromatic light sheet to illuminate the sample. For example, the holder may be located in relation to the light intensity modulator and the light sheet generator such that, when the sample is provided at the holder, the intensity modulated polychromatic light sheet illuminates the sample.

Typically, the entire intensity modulated polychromatic light sheet illuminates the sample, but some embodiments may apply a solution where only part of the intensity modulated polychromatic light sheet illuminates the sample.

The holder may, for example, be a stand for receiving the sample. The sample may be provided without any container (e.g., if the medium is solid, or a gel). Alternatively, the sample may be provided in a container (e.g., if the medium is liquid, or a gas), in which case the holder may be suitable for receiving the container with the sample comprised therein. An example container is a cuvette (e.g., a glass cuvette).

The optical sensor 150 is configured to record (over the light spectrum) intensity of light exiting the sample and after it has been spectrally separated by the dispersive element 3. The recorded intensity can then be used to determine the one or more optical parameters.

Typically, the optical sensor may be a camera (e.g., a charge-coupled device—CCD—camera or a scientific complementary metal-oxide-semiconductor—sCMOS—camera).

The optical sensor 150 is configured to record the intensity of light that has been spectrally separated by the dispersive element 3 after exiting the sample opposite to the illumination (so called transmitted light, illustrated as 195 in FIGS. 1a and 1b).

With reference to FIGS. 1a and 1b, the light intensity modulator 130 comprises: an optical holder 180 for a grating, the optical holder being electronically controlled and movable in the third spatial dimension 103; and a grating 4 the assembly comprises plurality of periodical pattern 11,12,13. By moving the grating 4 sideways or in the third spatial direction 103, the phase of the periodic pattern can be phase shifted quickly and exactly accurately. However, in alternative embodiment, the light intensity modulator 130 may comprise: an optical holder 180 for a grating, the optical holder being electronically controlled and movable in the first spatial dimension 101; and a grating 2 the assembly comprises a periodical pattern 11. This may save space as the grating can be smaller having only one periodic pattern. The phase shift is accomplished by a precise movement in the first spatial direction.

The second aspect of this disclosure shows a method of using the assembly according to the first aspect for measuring one or more optical parameters of a medium, the method comprising: providing 410 the holder 145 with a sample 140 of the medium; illuminating 420 the sample by the intensity modulated light sheet 193 provided by the light sheet generator 110 and the light intensity modulator 130 of the assembly; recording 430, by the optical sensor 150 of the assembly, a plurality of separated light sheets 195; and determining 460 the one or more optical parameters based on the recorded plurality of separated light sheets 195.

According to one embodiment the method comprises: moving 415 the optical of the light intensity modulator 130 in the third spatial dimension so that light propagating in the assembly hits the next subsequent first periodic pattern 11,12,13 of the grating or, if present, second periodic pattern 14,15,16; iterating the method from the illuminating S2 step.

According to one embodiment the method comprises: moving 416 the optical holder of the light intensity modulator 130 in the first spatial dimension a predetermined portion of a phase of the periodical pattern 11 so that light propagating in the assembly is phase shifted the predetermined portion of a phase; iterating the method from the illuminating S2 step.

When determining the one or more optical parameter using the assembly with the grating an array of the n last recorded measurement with different periodic patterns are kept. When a new recording is made using a periodic pattern, that recoding replaces the last measurement on that position in the array for that unique periodic pattern. If the second period pattern is present on the grating a corresponding array (or part of the same but extended array) is kept for the second periodic patterns. In this way a new and updated calculation for determining the one or more optical parameter can be made for each single new recoding. The effect is a real time result based on the n last recordings made when using the grating of FIG. 4, but updated for each single recording. Live measurement are thereby achieved.

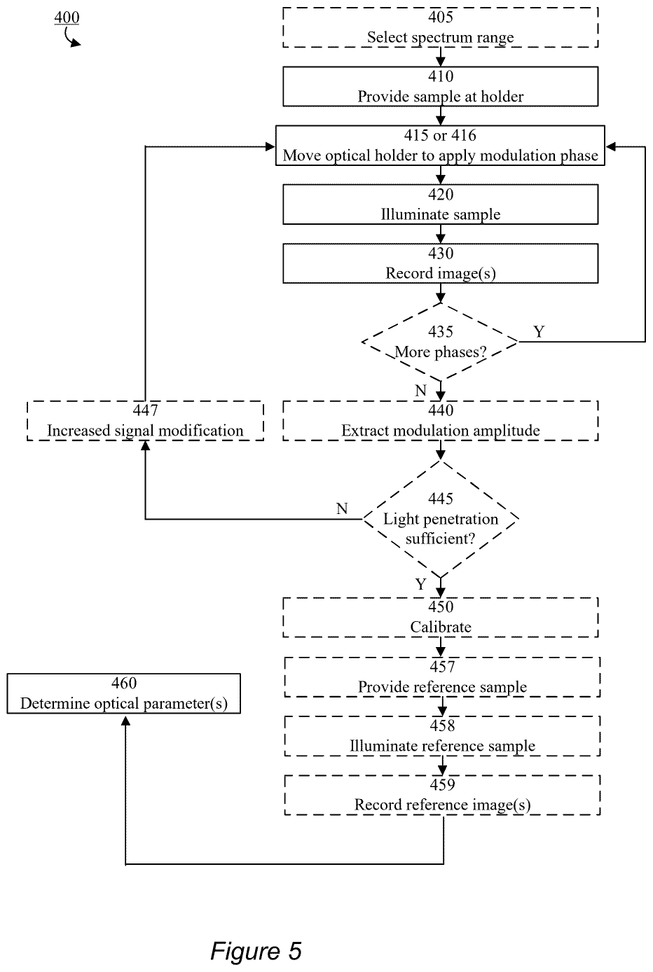

FIG. 5 is a flowchart illustrating an example method 400 of using of an assembly (e.g., any of the assembly variants described in connection with FIGS. 1a-4) for measuring one or more optical parameters of a medium.

The method may begin in optional step 405, where a range of a light spectrum of the polychromatic light sheet (e.g., 192) to be generated at the assembly is selected.

In step 410, a sample of the medium is provided at a holder of the assembly, such that (e.g., by location and/or orientation) an intensity modulated polychromatic light sheet to be provided at the assembly will illuminate the sample.

In step 420, the sample is illuminated by the intensity modulated polychromatic light sheet (e.g., by switching on a light source of a light sheet generator configured to provide a polychromatic light sheet being intensity modulated by a light intensity modulator as exemplified above).

The modulated illumination enables determination of the single light scattering intensity from the measurement of the modulation amplitude of the recorded signal. Application of different phases (by displacing the modulation) makes it possible to determinate the intensity of the single light scattering for the entire wavelength range at interest.

For example, from images of measurements for different phases, a reconstructed image may be created after image post-processing such that the reconstructed image is free from multiple light scattering intensities and from unwanted reflections. The reconstructed image can thus be used to estimate the extinction coefficient of the medium of the sample more accurately than if multiple light scattering intensities could not be suppressed.

In step 430, at least one image is recorded—by an optical sensor—of intensity of light exiting the sample opposite to the illumination as exemplified above in connection with FIG. 1a and FIG. 1b.

If more phases are to be measured (Y-path out of optional step 435), the method returns to 420 where a new phase is applied, and step 430 is repeated for the new phase. If no more phase are to be measured (N-path out of optional step 435), the method proceeds to optional step 440.

In optional step 440, the modulation amplitude is extracted from the recorded images. For example, this may be achieved by post-processing the recoded image(s) and extracting the amplitude of the recorded modulation for both intensity of light exiting the sample opposite to the illumination (detection of transmitted signal). As mentioned above, the modulation amplitude may be used to discriminate between first and higher order scattering, for example.

In optional step 445, it is determined whether the penetration of light into the sample is sufficient for extracting the information at interest from the recorded image(s). For example, optional step 445 may comprise determining whether the extracted modulation amplitude is higher than a threshold value to determine whether the penetration of light into the sample is sufficient.

If the penetration of light into the sample is not sufficient (N-path out of optional step 445), the method may comprise in optional step 447 increasing light intensity of the light source or enhance integration time of the optical sensor, and returning to step 420 for repeating the measurements with the adjustment applied.

If the penetration of light into the sample is sufficient (Y-path out of optional step 445), the method may continue to optional step 450, where the measurement may be calibrated. For example, the calibration may comprise application of displaceable monochromatic filter(s) (or filters with a relatively narrow bandwidth) to provide spatial calibration of the light spectrum.

According to some embodiments of the various approaches presented herein, the intensity modulation may enable removal (or at least suppression) of one or more of: background noise, background reflections, diffused transmitted light.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. An assembly for measurements of one or more optical parameters of a
medium, the assembly comprising:
a light sheet generator configured to provide a light sheet extending in a first spatial dimension, wherein the light sheet has a propagation path in a second spatial dimension, wherein the light sheet generator comprises a polychromatic light source emitting polychromatic light and light sheet generating optics to reform the light from the polychromatic light source into the light sheet;
a light intensity modulator configured to provide an intensity modulated light sheet by applying—to the light sheet—an intensity modulation having a periodical, or substantially periodical, pattern in the first spatial dimension;
a holder for a sample of the medium, configured to enable the intensity modulated light sheet to illuminate the sample;
a dispersive element arranged to receive the light transmitted through the sample and arranged to split the light sheet into its spectral components so that each spectral component forms its own separated light sheet; and
an optical sensor configured to record the separated light sheets in two dimensions.

2. The assembly according to claim 1, wherein the dispersive element is a diffraction grating.

3. The assembly according to claim 1, wherein the dispersive element is a prism.

4. The assembly according to claim 1, wherein the light sheet generator is arranged fastened and abutting to the light intensity modulator.

5. The assembly according to claim 1, wherein the light intensity modulator is arranged fastened and abutting the sample holder.

6. The assembly according to claim 1, wherein the light intensity modulator is an imprint on the sample holder or container.

7. The assembly according to claim 1, wherein the optical sensor is a 2D CCD camera.

8. The assembly according to claim 1, wherein light intensity modulator comprises:
an optical holder for a grating, the optical holder being electronically controlled and movable in a third spatial dimension; and
a grating comprising a plurality of periodical pattern.

9. The assembly according to claim 1, wherein light intensity modulator comprises:
an optical holder for a grating, the optical holder being electronically controlled and movable in the first spatial dimension; and
a grating comprising a periodical pattern.

10. A method of using the assembly according to claim 1, for measuring one or more optical parameters of a medium, the method comprising:
providing the holder with a sample of the medium;
illuminating the sample by the intensity modulated light sheet provided by the light sheet generator and the light intensity modulator of the assembly;
recording, by the optical sensor of the assembly, a plurality of separated light sheets; and
determining the one or more optical parameters based on the recorded plurality of separated light sheets.

11. The method according to claim 10 using the assembly, the method further comprising:
moving the optical holder of the light intensity modulator in the third spatial dimension so that light propagating in the assembly hits the next subsequent first periodic pattern of the grating or, if present, second periodic pattern;
iterating the method from the illuminating step.

12. The method according to claim 10 using the assembly, the method further comprising:
moving the optical holder of the light intensity modulator in the first spatial dimension a predetermined portion of a phase of the periodical pattern so that light propagating in the assembly is phase shifted the predetermined portion of a phase;
iterating the method from the illuminating step.
